(19) United States
(12) Patent Application Publication
(10) Pub. No.: US 2013/0192070 A1
(43) Pub. Date: Aug. 1, 2013

(54) STRAINER DEVICE AND METHOD FOR MANUFACTURING THE STRAINER

(71) Applicant: Yuval Amit, Herzeliya, IL (US)

(72) Inventor: Yuval Amit, Herzeliya, IL (US)

(21) Appl. No.: 13/802,517

(22) Filed: Mar. 13, 2013

Related U.S. Application Data
(63) Continuation-in-part of application No. 11/837,803, filed on Aug. 13, 2007, now abandoned.
Application No. 11/837,803 is a continuation of application No. 29/277,510, filed on Feb. 28, 2007, now Pat. No. D572522.

(51) Int. Cl. A47J 31/06

(52) U.S. Cl. CPC A47J 31/06
USPC 30/325; 29/428

(57) ABSTRACT

A straining device and a method for manufacturing a straining device are provided. The straining device includes a handle, a frame, which is positioned at an end of the handle, and a compartment containing a medium to be strained. The compartment includes a top porous surface and a bottom porous surface, and is affixed to the frame. Further, the compartment is configured so as to strain the medium through at least one of the top porous surface and the bottom porous surface. The medium to be strained may include a beverage, medicine, or soup ingredient. Accordingly, the straining device provides a convenient apparatus for preparing a beverage, a food, or a medicine, and for a variety of utensil applications such as stirring or collecting and adding an additive.

### RELATED APPLICATIONS

This application is a continuation-in-part of U.S. Ser. No. 11/837,803, filed Aug. 13, 2007, which is a continuation of and claims priority from U.S. Ser. No. 29/277,510, filed Feb. 28, 2007, the entire disclosure of which is incorporated herein by reference.

### BACKGROUND

1. Field of the Invention

Apparatuses and methods consistent with the present invention relate generally to a staining or infusing devices and, more particularly, to an improved straining device that may be used for the preparation of various types of beverages and foods, such as tea, coffee, soup, or the like.

2. Related Art

It is often desirable to prepare an individual serving of a beverage or a food, such as tea, coffee, soup, or the like, without using cumbersome equipment such as coffee pots, tea pots, microwaves, etc. It is also desirable to collect and add various additives such as sweeteners or flavorings to such a beverage or a food in order to enhance flavor. Further, it is often desirable to stir or mix the serving being prepared. And, it is desirable to prepare such an individual serving of a beverage or a food in a simple, efficient, and rapid manner that minimizes the number of utensils necessary for preparation and clean-up.

Strainers for individual beverage servings are known in the art. Further, straining spoons for the preparation of beverages have also been developed. For instance, U.S. Pat. Nos. 3,946,652, 4,215,628, and 4,338,338 disclose various straining devices for making beverages, such as tea. However, each of these prior art devices may provide one benefit, but be lacking in other areas, and none enables concurrent delivery of both the strained or infused substance (tea, coffee, etc.) and additives (sugar, etc.) and enable using the device for stirring.

The conventional straining devices suffer from numerous long-standing but unresolved disadvantages. For example, conventional straining spoons fail to efficiently dispense the beverage ingredient that is pre-filled therein. Since only one of the walls of conventional straining spoons has apertures formed therein, such conventional straining spoons only permit the free flow of liquid into and out of the compartment having the beverage ingredient from a single side of the straining spoon. Additionally, conventional straining spoons are complicated and expensive to manufacture. Indeed, conventional straining spoons consist of compartment defined by two walls with a beverage ingredient pre-filled therebetween. But, such pre-filling methods are complex and are relatively expensive to implement, thereby making it prohibitive to be disposable.

Accordingly, there is a need for an infusion/straining device which allows preparation of an individual serving of a beverage or a food without using cumbersome equipment. There is also a need for a straining device which allows for an increased flow of liquid to/from the beverage ingredient and which thereby allows the desired beverage or food to be prepared in a quick and efficient manner. Lastly, there is a need for such a straining device to be suitable for many of the purposes for which spoons are typically employed, such as stirring and collecting and adding various additives to a beverage or a food. Moreover, there is a need for a straining device which is simple and inexpensive to manufacture. Further, there is a need for an infusion/straining device which can be manufactured using conventional beverage strainers such as teabags and coffee bags, without requiring complex and expensive pre-filling techniques or using electrical machines in the beverage making process.

### SUMMARY

The following summary is included in order to provide a basic understanding of some aspects and features of the invention. This summary is not an extensive overview of the invention, and as such it is not intended to particularly identify key or critical elements of the invention, or to delineate the scope of the invention. The sole purpose of this summary is to present some concepts of the invention in a simplified form as a prelude to the more detailed description that is presented below.

Exemplary embodiments of the present invention relate to an infusion or straining device that addresses many of the problems discussed above, and other needs which are not expressly mentioned above. Also, the present invention is not required to overcome the disadvantages described above, and an exemplary embodiment of the present invention may not overcome any of the problems described above.

In various embodiment of the invention, a disposable spoon is provided which is pre-loaded with the substance for making a beverage, such as tea leaves or coffee powder or particles. Unlike conventional mechanical metallic tea strainers, the inventive teaspoon is disposable and ready to use (i.e., the tea leaves are pre-filled), and it can also be used as a conventional teaspoon to add sweeteners or other additives. The inventive spoon may be easily and cheaply manufactured using conventionally available technology.

According to an aspect of the present invention, there is provided a straining device comprising: a handle; a frame, which is positioned an end of the handle; and a compartment, containing a medium to be strained, wherein the compartment is supported by the frame; wherein the compartment comprises a top porous surface; wherein the compartment comprises a bottom porous surface; and wherein the compartment is configured so as to dispense the medium through at least one of the top porous surface and the bottom porous surface. The medium to be strained may be disposed between the top porous surface and the bottom porous surface. The medium to be strained may comprise a beverage ingredient, tea, coffee, a food ingredient, instant soup powder, a medicine ingredient, etc. The top porous surface may be configured so as to generally preclude sweetener granules from entering the compartment. The frame may be formed around a border of the compartment. The frame and the compartment may form an assembly that is generally concave in shape. The frame and the handle may comprise a plastic material. The frame and the compartment may form an assembly that comprises a concave portion of a spoon. The compartment may comprise a teabag.

According to another aspect of the present invention, there is provided a method for manufacturing a straining device, the method comprising: positioning a medium to be strained between a top porous surface and a bottom porous surface; positioning the top porous surface and the bottom porous surface so as to define a compartment, wherein the compartment is configured so as to dispense the medium through at least one of the top porous surface and the bottom porous surface; forming a frame and a handle; and positioning the compartment relative to the frame such that the compartment is supported by the frame. The medium to be strained may comprise a beverage ingredient, tea, coffee, a food ingredient, soup, a medicine ingredient, etc. The method may further comprise configuring the top porous surface so as to generally preclude additive granules from entering the compartment. The method may comprise forming the frame around a border of the compartment. The method may comprise forming the frame and the compartment into an assembly that is generally concave in shape. The frame and the handle may comprise a plastic material. Finally, the method may comprise configuring the frame and the compartment into an assembly comprising a concave portion of a spoon.

According to another aspect, a strainer device is provided in the form of a disposable spoon, comprising a disposable spoon having a handle and a concave bowl formed integrally as one piece, wherein the concave bowl is formed with an aperture at a lower part of the concave bowl thereby defining a frame; a liquid permeable compartment containing a medium to be strained, the compartment comprising a top porous thin sheet and a bottom porous thin sheet, the top and bottom thin sheets being sealed together at periphery thereof to define a band enclosing a straining section, the straining section containing medium to be strained, the straining section being shaped and sized to fit inside the aperture, such that the band extends beyond the aperture and overlaps the frame; wherein the compartment is affixed to the concave bowl by the band being affixed to the frame such that the straining section is positioned inside the aperture; wherein the concave bowl is configured to collect and hold additives and support the additives on top of the top porous thin sheet, to thereby retain the spoon-like appearance and function of the device; wherein the compartment is configured, so as to permit liquid to pass through the compartment via the top porous thin sheet and the bottom porous thin sheet so as to strain the medium; and, wherein the seal forms a peripheral seal section of the compartment. An infusion indicator may be included and is configured to indicate the medium included in the compartment, e.g., caffeinated or decaffeinated medium. The infusion indicator may comprise color coded indicator, a geometrical shape formed integrally with the handle part of the spoon, etc.

According to yet another aspect, a method for manufacturing a disposable straining device is provided, the method comprising: forming a disposable teaspoon having a handle and a concave bowl formed as a single integral piece, while forming an aperture at bottom part of the concave bowl to thereby define a frame; positioning a medium to be strained between a top porous sheet and a bottom porous sheet; positioning the top porous sheet and the bottom porous sheet so as to define a compartment and affixing the top porous surface and the bottom porous surface to each other to thereby form a peripheral band enclosing the compartment, such that the compartment assumes a shape conforming to fit within the aperture and the band is sized to extend beyond the aperture and overlap the frame, wherein the compartment is configured so as to allow liquid to pass through the top porous sheet and the bottom porous sheet; affixing the compartment to an interior periphery of the frame by adhering the band to the frame such that the band overlaps the frame and positions the compartment within the aperture; wherein the concave portion configured to collect and hold additives while also allowing liquid to pass through the top porous surface, to thereby retain the spoon-like appearance and function of the device. The method may further comprise forming an indicator on the spoon to indicate a type of the medium included inside the compartment.

### BRIEF DESCRIPTION OF THE DRAWINGS

The accompanying drawings, which are incorporated in, and constitute a part of, this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

The aspects of the present invention will become more apparent by describing in detail exemplary embodiments thereof with reference to the accompanying drawings, in which:

FIG. 1 shows a top view of a straining device consistent with an exemplary embodiment of the present invention;

FIG. 2 shows a bottom view of a straining device consistent with an exemplary embodiment of the present invention;

FIG. 3 shows a side view of a straining device consistent with an exemplary embodiment of the present invention;

FIG. 4A shows a cross-sectional view, while FIG. 4B shows an exploded view of a straining device consistent with an exemplary embodiment of the present invention;

FIG. 5 shows a perspective view of a straining device consistent with an exemplary embodiment of the present invention demonstrating use of the straining device to collect an additive;

FIG. 6 shows a perspective view of a straining device consistent with an exemplary embodiment of the present invention demonstrating use of the straining device to position an additive over a beverage to be prepared;

FIG. 7 shows a perspective view of a straining device consistent with an exemplary embodiment of the present invention immersed in a beverage for beverage preparation;

FIG. 8 shows a perspective view of a straining device consistent with an exemplary embodiment of the present invention after the straining device has been immersed in a beverage and the beverage has been prepared;

FIG. 9 shows a flow diagram of a method for manufacturing a straining device consistent with an exemplary embodiment of the present invention.

FIGS. 10A and 10B illustrate another embodiment, wherein an infusion indicator is included to convey to the user the type of medium included in the compartment.

### DETAILED DESCRIPTION

Reference will now be made in detail to exemplary embodiments of the present invention, which are illustrated in the accompanying drawings, wherein like reference numerals refer to like elements throughout. The exemplary embodiments provided below are intended in all respects to be exemplary only, with the true scope and spirit of the invention being defined by the following claims.

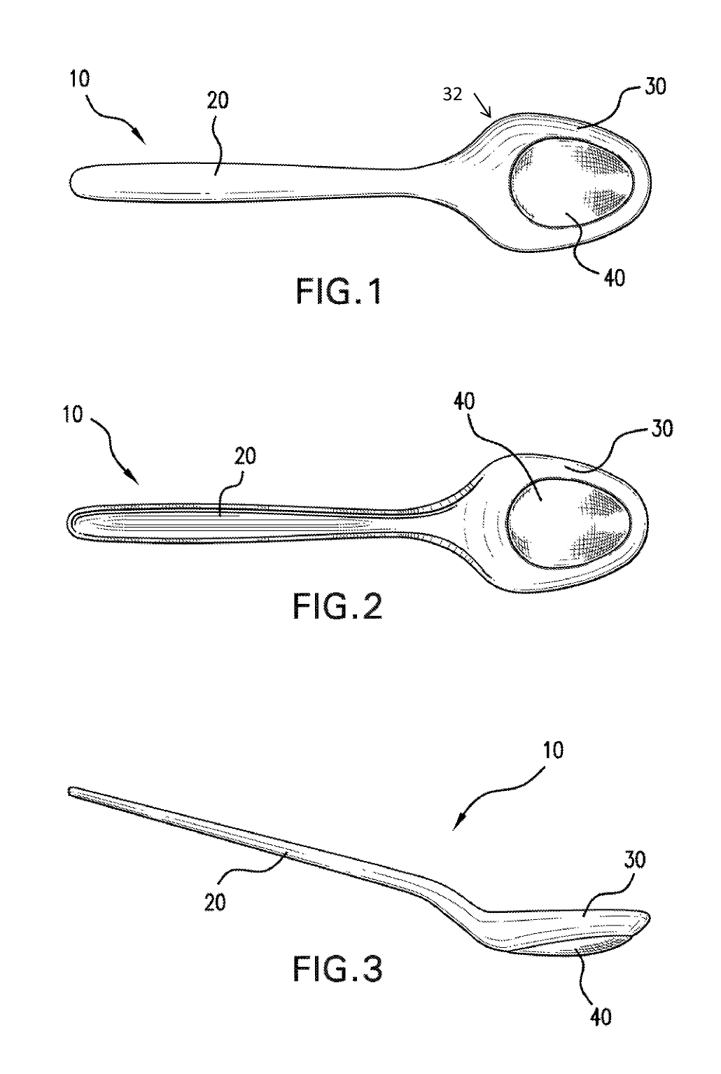

FIGS. 1, 2, 3, 4A and 4B show a top view, a bottom view, a side view, a cross-sectional view, and an exploded view, respectively, of a straining device 10 consistent with an exemplary embodiment of the present invention. As shown in FIGS. 1, 2, 3, 4A and 4B, the straining device 10 comprises a disposable teaspoon made of plastic, e.g., by extrusion, and a teabag attached to an opening or aperture in the bowl part of the teaspoon. The plastic teaspoon has an elongated handle 20, which is formed so that it may be easily grasped by a user. The surface of the handle 20 may be textured in a variety of different patterns so as to enhance the grip of the handle 20, to provide an ornamental design, or for both purposes. The teaspoon further comprises a concave bowl part 31 having an aperture 34 formed therein so as to define a frame 30, which is positioned at an end of the handle 20. The frame 30 is made sufficiently wide such that due to the concavity of the bowl, the spoon can be used to load granulates, such as sweeteners, in addition to having the teabag attached thereto.

According to the present invention, the frame 30 may be connected to the handle 20 by a variety of different methods know in the art, or may be formed integrally with the handle 20. In one embodiment the handle 20 and frame 30 are manufactured by conventional plastic injection molding as a single piece, in the same manufacturing process disposable plastic spoons are made, except that an opening 34 is made in the bowl part of the spoon. Of course, the present invention is not limited to plastic material and a wide variety of materials can be used to form the handle 20 and the frame 30. For example, recyclable materials, such as corn plastic or condensed paper can be used.

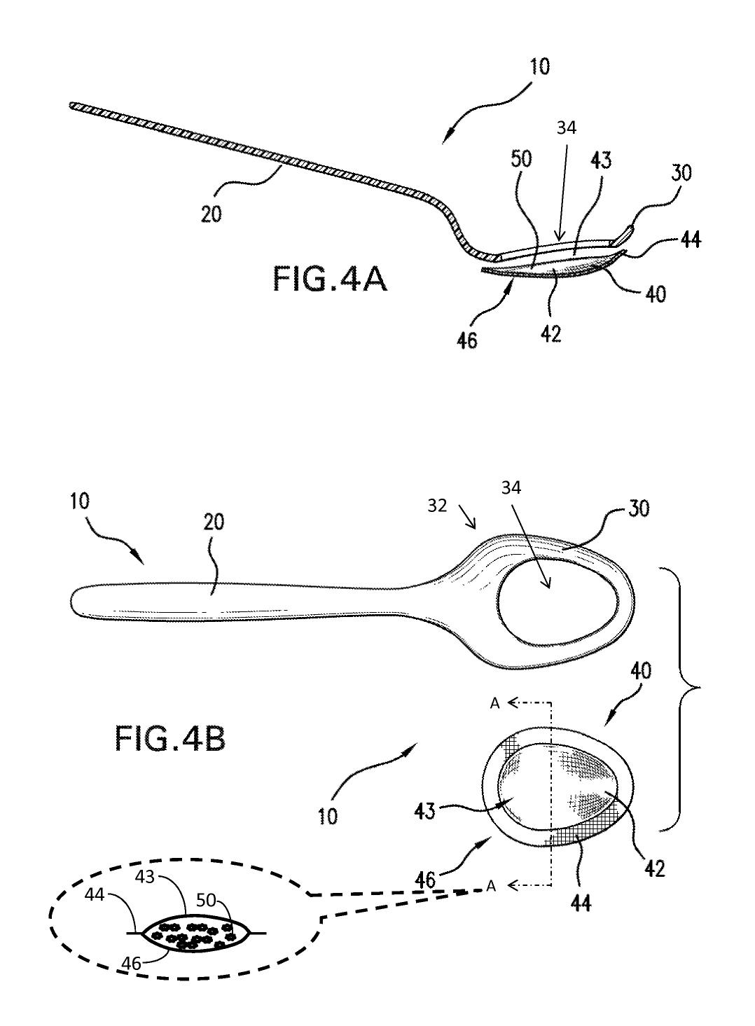

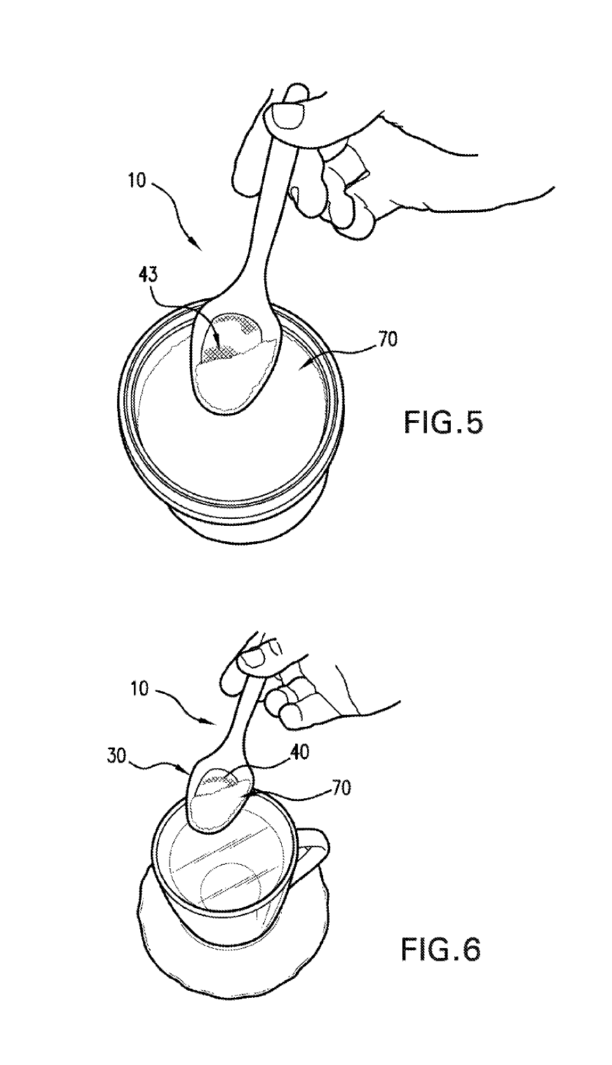

According to the exemplary embodiment shown in FIGS. 1, 2, 3, 4A and 4B, the straining device 10 comprises a compartment 40, which is positioned in aperture 34 and supported by the frame 30. The frame 30 may be formed around a border of the compartment 40. As shown in FIG. 4B, the compartment 40 is roughly oval in shape and is affixed to the interior periphery of the frame 30. According to the exemplary embodiment shown in FIGS. 4A and 4B, the compartment 40 has a straining section 42, which contains the substance to be strained, and a peripheral seal section 44, which seals the substance to be strained and which is used to affix the compartment to the frame 30. As shown in the callout of FIG. 4B, the peripheral seal section is a flat band made by adhering the edges of the top and bottom straining fabrics 43 and 46, respectively, to each other, thereby containing the tealeaves inside straining section 42. As shown in FIG. 4A, the band 44 is then attached to the frame 30, such that the straining section 42 is positioned within the aperture 34.

As shown in detail by FIGS. 4A and 4B, the compartment 40 comprises a top porous surface 43 and a bottom porous surface 46. As shown in detail in FIGS. 4A and 4B, the compartment 40 is configured such that a medium or substance 50 to be strained or infused is disposed between the top porous surface 43 and the bottom porous surface 46. In particular, the compartment 40 is configured to hold the medium 50 therein. The top porous surface 43 and the bottom porous surface 46 are joined at the peripheral seal section 44 by conventional methods, such as heat-seal or adhesive, to thereby prevent any part of the medium 50 from exiting the compartment 40, and form a band around the straining section 42.

Moreover, the compartment 40 is configured such that, when the compartment 40 is immersed in a liquid, the liquid may pass through the top porous surface 43 and the bottom porous surface 46, to thereby strain the medium 50 and effect the preparation of a beverage or a food. The exemplary embodiment shown in FIGS. 4A and 4B allows for an increased flow of liquid to/from the medium 50 by allowing liquid to flow through the compartment 40 and thereby allow the beverage or food to be prepared in a quick and efficient manner.

The top porous surface 43 and the bottom porous surface 46 may be generally in the form of a thin sheet of a mesh, a fabric, a porous membrane or a web, comprised of, for example, porous silk, muslin, paper, nylon, plastic, etc., but the present invention is not limited to these materials. Indeed, the top porous surface 43 and the bottom porous surface 46 can comprise any porous material which permits the free flow of liquid into and out of the compartment 40 when the compartment 40 is immersed in a liquid, but nevertheless preclude the particles of the medium 50 from escaping from the compartment 40 prior to immersion of the compartment 40 in the liquid. In one embodiment of the invention, the top porous surface 43 and the bottom porous surface 46 are made of material that is conventionally used for the production of conventional teabags. In one embodiment the entire compartment 40 is made using conventional technology used for the manufacture of teabags, except that the shape of the compartment is designed so that the peripheral seal section 44 matches the shape of the frame 30 and the compartment 40 matches the shape of the aperture in the concave bowl of the spoon. Such a design drastically reduces the manufacturing costs of the inventive straining device. Moreover, when the compartment 40 is manufactured using conventional teabag manufacturing techniques and the handle and frame are manufactured using conventional techniques for manufacturing disposable plastic spoons, the combined elements result is a straining device that is easy and cheap to manufacture so that it is readily disposable upon a single use.

Consistent with the present invention, the medium 50 may comprise a dry, powdered, gel-like, or granulated beverage ingredient or food ingredient such as tea, coffee, cocoa, dehydrated soup, spices and leaves, or the like, but the present invention is not limited thereto. In fact, the medium 50 may comprise any type of ingredient, including but not limited to, a beverage ingredient, a food ingredient, or a medicine ingredient, that can be strained through a porous surface.

According to the exemplary embodiment shown in FIGS. 1, 2, 3, 4A and 4B, the straining device 10, as a whole, is generally spoon-like in shape, having a concave bowl section that performs the functions of a standard spoon bowl, especially containing foodstuffs, such as sweeteners. As shown in FIGS. 1, 2, 3, 4A and 4B, the frame 30/compartment 40 assembly is generally concave in shape, thereby retaining the spoon-like appearance and function of the device. Accordingly, the straining device 10 is configured to collect and hold solid material, including additives such as sugar particles, sweeteners, and salt, therein, while also allowing liquid to pass through the top porous surface 43 and the bottom porous surface 46.

As such, the straining device 10 may not only be used to dispense a medium 50, but may also be used to collect and hold an additive in the frame 30/compartment 40 assembly, and to provide such an additive to the beverage or food being prepared concurrently with straining the substance 50. An exemplary procedure describing use of the straining device 10 to prepare a beverage is illustrated sequentially in FIGS. 5, 6, 7 and 8.

FIG. 5 shows a perspective view of an exemplary straining device 10 used to collect and hold an additive 70. As shown in FIG. 5, the additive 70 is disposed on the top porous surface 43, and the top porous surface 43 generally precludes the additive 70 from entering the compartment 40.

FIG. 6 shows a perspective view of the exemplary straining and stirring device 10 used to position the additive 70 over a beverage to be prepared. As shown in FIG. 6, the frame 30/compartment 40 assembly is generally concave in shape and is configured to hold the additive 70 until the compartment 40 is immersed in the beverage.

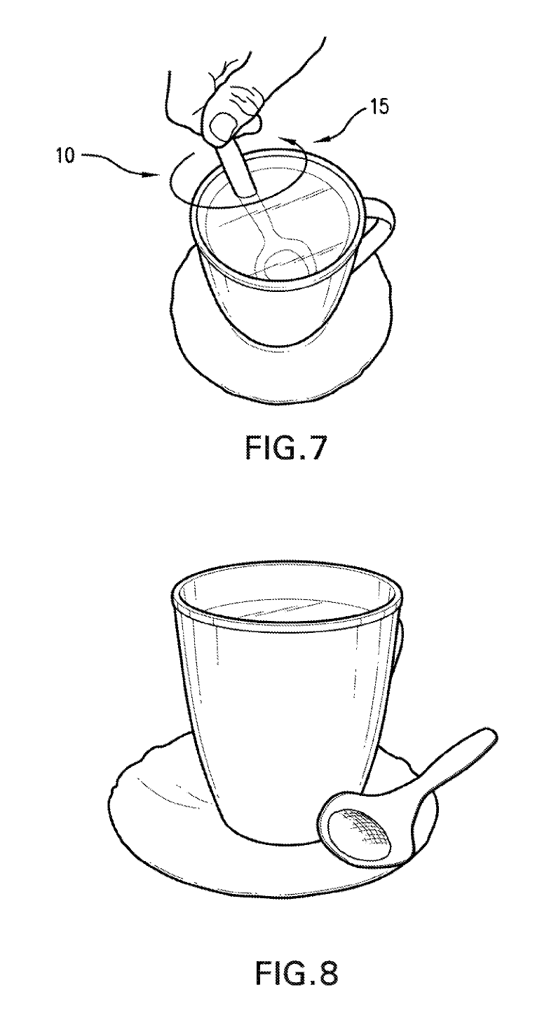

FIG. 7 shows a perspective view of the exemplary straining and stirring device 10 immersed in a beverage for beverage preparation. As depicted in FIG. 7, the additive 70 (previously shown in FIG. 5 and FIG. 6) has been added to the beverage and is no longer disposed on the top porous surface 53. Moreover, as the spoon 10 is stirred in the beverage, as illustrated by arrow 15, the medium 50 is strained into the beverage. According to the exemplary embodiment shown in FIG. 7, the straining device 10 may be stirred so as to conveniently and concurrently strain the medium 50 and dispense the additive 70 throughout the beverage liquid with the same motion. As the liquid is stirred, the liquid enters through the top porous surface 43, pass through the medium 50, and exits out the bottom porous surface 46.

FIG. 8 shows a perspective view of the exemplary straining device 10 after the straining device 10 has been immersed in the beverage, stirred, and the beverage has been prepared. As shown in FIG. 8, the present invention obviates the need for cumbersome equipment to prepare the desired beverage. Further, as shown in FIG. 8, the exemplary straining device 10 obviates the need for both a teabag, or the like (to dispense a desired medium) and a separate utensil to collect and add a desired additive to a beverage to be prepared. To the contrary, only the infusing/straining device 10 is needed to infuse/strain the medium 50, to add the additive 70, and to mix both into the liquid to provide the beverage, thus making beverage preparation easier, more convenient, more efficient, and less expensive. When the straining device 10 is manufactured according to the embodiments disclosed herein the device is disposable after the preparation of the beverage.

According to the exemplary embodiments described above, the size and capacity of the frame 30/compartment 40 assembly are dimensioned so as to accommodate approximately a teaspoon volume therein. However, the present invention is not limited to this exemplary size and capacity and the frame 30/compartment 40 assembly may be dimensioned so as to accommodate a variety of different volumes such as a tablespoon, 25 milliliters, or the like, in accordance with the medium desired to be strained.

Likewise, as described in the exemplary embodiments presented above, the straining device 10 is generally spoon-like in shape, but the present invention is not limited thereto. To the contrary, the straining device 10 may comprise a variety of shapes such as a handle and frame which are generally flat, rather than curved in shape. Further, the frame/compartment assembly may comprise a variety of shapes consistent with the present invention, such as rectangular, square, oval, or circular shapes. Also, the frame 30/compartment 40 assembly is not limited to being concave in shape, rather, the frame 30/compartment 40 assembly may comprise any shape so long as it is configured to collect and add an additive to a beverage.

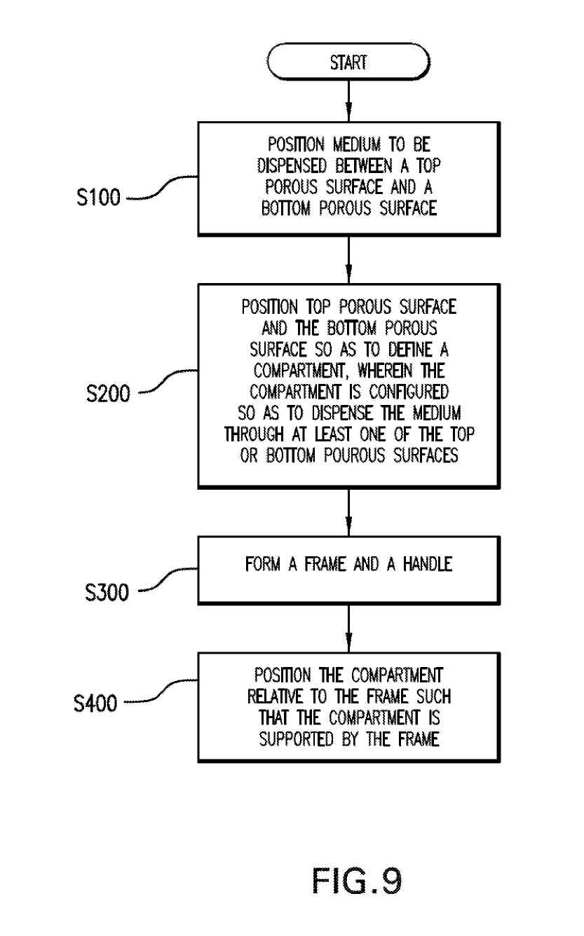

As shown in FIG. 9, an exemplary embodiment of the present invention provides a method for manufacturing a straining device. In operation S100, a medium to be strained/infused is positioned between a top porous surface and a bottom porous surface. Then, in operation S200, the top porous surface and the bottom porous surface are positioned so as to define a compartment and are sealed together by forming the peripheral seal section and defining flat band 44. As noted above, the peripheral seal section may be made using heat seal or other methods. According to the exemplary embodiment referenced in FIG. 9, the compartment is configured as to strain the medium by allowing liquid to flow through the top porous surface and the bottom porous surface.

In operation S300, a frame and a handle are formed. In one embodiment the frame and handle are formed in a single plastic molding or extrusion process. The resulting spoon has a single-walled handle and a single-walled concave bowl with an opening or aperture in the middle of the bowl. The aperture is oval or elliptical-shaped, and the compartment 40 is sized to fit inside the aperture, such that the band 44 extends beyond the aperture and overlaps the frame of the bowl. Finally, in operation S400, the compartment is positioned and affixed to the frame, such that the compartment is supported by the frame. For example, the peripheral seal section or band 44 may be heat sealed or adhered to the frame 30. Additionally, the frame 30 and the compartment assembly may be configured so as to comprise a concave portion of a spoon, so as to enable dispensing of additives concurrent with straining the medium. In one embodiment, the compartment is affixed to the frame using heat-seal operation.

As indicated above, to form a disposable straining spoon, the frame and handle are made in one plastic injection mold, while the compartment is made using conventional materials used for production of conventional teabags. The compartment is then heat-sealed or adhered to the plastic frame.

According to the exemplary method referenced in FIG. 9, the medium to be strained may comprise a beverage ingredient, for instance, such as tea, coffee, cocoa, etc. Alternatively, the medium to be strained may comprise a food ingredient such as a soup, or a medicine ingredient. Further, according to this exemplary method, the top surface may be configured so as to generally preclude sugar granules from entering the compartment.

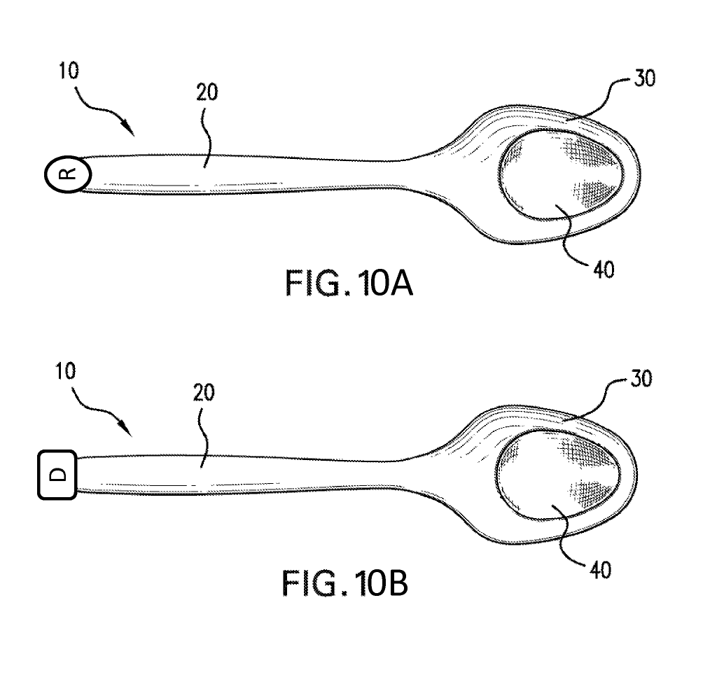

FIGS. 10A and 10B illustrate another embodiment, wherein an infusion indicator is included to convey to the user the type of medium included in the compartment 40. For example, FIG. 10A illustrate an indicator in the form of a flat circle at the edge of the handle, while FIG. 10B illustrates a rectangle at the edge of the handle. For example, the circle may indicate regular tea, while the rectangle may indicate decaffeinated tea. In the examples of FIGS. 10A and 10B the letters “R” and “D” may also be included to symbolize regular and decaffeinated. Furthermore, the indicator may comprise a color coded plastic. For example, a red plastic may mean regular while a green plastic may mean decaffeinated.

As can be understood from the above description, the inventive straining and/or stirring device has several advantages and provide benefits not attainable by the devices of the prior art. Notably, the inventive device is easy and cheap to manufacture, making it conveniently disposable. The particular design of the inventive device also enables it to be used to concurrently perform dual functions. For example, when the device is a spoon used for making tea or coffee, the spoon is used both to dispense additives, such as sweetener, and to strain the tea at one single action. Moreover, the particular design of the spoon enables the straining to be performed efficiently, as during stirring of the liquid with the spoon, the liquid is able to pass through the compartment so as to strain the flavoring contained within the compartment. While some prior art device may be able to provide some of the benefits listed here, none is able to provide all of these benefits in the manner provided by the inventive device and at the same time be manufactured cost effectively to be disposable.

The present invention has been described in relation to particular examples, which are intended in all respects to be illustrative rather than restrictive. Various other implementations of the invention will be apparent to those skilled in the art from consideration of the specification and practice of the invention disclosed herein. It is intended that the specification and examples be considered as exemplary only, with a true scope and spirit of the invention being indicated by the following claims.

Notably, in the description and claims the terms infusing and straining are used rather loosely and interchangeably. It is understood that the action depends on the beverage's substance and form, i.e., whether in crushed leaves, powder, granulate form, etc. Similarly, the term additive is used to include any additive that may be added to the substance that is already included in the device, e.g., sweeteners, salt, etc. Also, while in the various embodiments an oval-shaped spoon is shown, the device may be made as any utensil and have other shapes. For example, the device may be formed as a spoon having a distinguished shape so as to enable easy recognition and distinction from a standard spoon.

What is claimed is:

1. A strainer device in the form of a disposable spoon, comprising:
a disposable spoon having a handle and a concave bowl formed integrally as one piece, wherein the concave bowl is formed with an aperture at a lower part of the concave bowl thereby defining a frame;
a liquid permeable compartment containing a medium to be strained, the compartment comprising a top porous thin sheet and a bottom porous thin sheet, the top and bottom thin sheets being sealed together at periphery thereof to define a band enclosing a straining section, the straining section containing medium to be strained, the straining section being shaped and sized to fit inside the aperture, such that the band extends beyond the aperture and overlaps the frame;
wherein the compartment is affixed to the concave bowl by the band being affixed to the frame such that the straining section is positioned inside the aperture;
wherein the concave bowl is configured to collect and hold additives and support the additives on top of the top porous thin sheet, to thereby retain the spoon-like appearance and function of the device;
wherein the compartment is configured, so as to permit liquid to pass through the compartment via the top porous thin sheet and the bottom porous thin sheet so as to strain the medium; and,
wherein the seal forms a peripheral seal section of the compartment.

2. The straining device according to claim 1, wherein the medium to be strained comprises a beverage ingredient.

3. The straining device according to claim 1, wherein the medium to be strained comprises tea leaves.

4. The straining device according to claim 1, wherein the disposable spoon comprises extruded or molded plastic.

5. The straining device according to claim 1, wherein the disposable spoon comprises corn plastic.

6. The straining device according to claim 1, wherein the disposable spoon comprises condensed paper.

7. The straining device according to claim 1, further comprising an infusion indicator providing an indication of type of medium included in the compartment.

8. The straining device according to claim 7, wherein the infusion indicator is configured to indicate caffeinated or decaffeinated medium.

9. The straining device according to claim 7, wherein the infusion indicator comprises color coded indicator.

10. The straining device according to claim 7, wherein the infusion indicator comprises a geometrical shape formed integrally with the handle part of the spoon.

11. The straining device according to claim 1, wherein the medium to be strained comprises one or a combination of tea, coffee, cocoa, soup, sweetener, concentrate, and medicine ingredient.

12. A method for manufacturing a disposable straining device, the method comprising:
forming a disposable teaspoon having a handle and a concave bowl formed as a single integral piece, while forming an aperture at bottom part of the concave bowl to thereby define a frame;
positioning a medium to be strained between a top porous sheet and a bottom porous sheet;
positioning the top porous sheet and the bottom porous sheet so as to define a compartment and affixing the top porous surface and the bottom porous surface to each other to thereby form a peripheral band enclosing the compartment, such that the compartment assumes a shape conforming to fit within the aperture and the band is sized to extend beyond the aperture and overlap the frame, wherein the compartment is configured so as to allow liquid to pass through the top porous sheet and the bottom porous sheet;
affixing the compartment to an interior periphery of the frame by adhering the band to the frame such that the band overlaps the frame and positions the compartment within the aperture;
wherein the concave portion configured to collect and hold additives while also allowing liquid to pass through the top porous surface, to thereby retain the spoon-like appearance and function of the device.

13. The method of claim 12, wherein affixing the top porous surface and the bottom porous surface to each other comprises heat sealing the top porous surface and the bottom porous surface to each other so as to form a peripheral seal section.

14. The method of claim 13, wherein affixing the compartment to the frame comprises heat-sealing the peripheral seal section to the frame.

15. The method according to claim 14, wherein the medium to be strained comprises a beverage ingredient.

16. The method according to claim 14, wherein the medium to be strained comprises one or combination of tea, coffee, soup, cocoa, and medicine.

17. The method according to claim 12, wherein forming a disposable spoon comprises injection molding or extruding the spoon from a plastic material.

18. The method according to claim 17, wherein forming a disposable spoon comprises injection molding or extruding the spoon from a corn plastic material.

19. The method of claim 12, further comprising forming an indicator on the spoon to indicate a type of the medium included inside the compartment.
